(19) United States
(12) Patent Application Publication
(10) Pub. No.: US 2005/0155916 A1
(43) Pub. Date: Jul. 21, 2005

(54) Cylindrical telescopic structure cyclone apparatus

(76) Inventors: Wlodzimierz J. Tuszko, Camarillo, CA (US); Wojciech Tuszko, Santa Monica, CA (US)

Correspondence Address: Wlodzimierz J. Tuszko, 5434 Camino De Ville, Camarillo, CA, 93012, US

(21) Appl. No.: 11/041,847

(22) Filed: Jan. 20, 2005

Related U.S. Application Data
(63) Continuation-in-part of application No. 10/623,326, filed on Jul. 19, 2003, now abandoned.

(51) Int. Cl. B07B 1/00; B04C 5/00

(52) U.S. Cl. 209/715; 209/720

(57) ABSTRACT

The cylindrical-telescopic cyclone apparatus structure pattern is the base for multi-compartment cylindrical-telescopic separation chamber cyclone as well as for one compartment conical separation chamber cyclone for both to be a most economic solution.

This Application is of Continuation in Part-Application to application Ser. No. 10/623326 dated Jul. 19, 2003, now abandoned. This invention is relates to an apparatus for continuous separation of solid-solid, solid-fluid suspension of particulate material. More specifically, the invention is directed to considerably increasing capacity and separation efficiency as well as to reduce pressure drop compared to the conventional conical cyclone separator.

### BACKGROUND

An early hydrocyclone method and apparatus from U.S. Pat. No. 453,105 (Bretney) issued May 28, 1891 in which there were two stages, in line, in the separating hydrocyclone. A frequent problem with this and later hydrocyclone devices are—so called “back mix,” high pressure drop and fast erosion of the conical portion.

A hydrocyclone is a device for creation of a free vortex, and it is the vortex that does the work in separating the particle matter from liquid.

The new features of the hydrocyclone-air core as the vortex driving force, was discovered and used to greatly improve the hydrocyclone collectors, Wlodzimierz J. Tuszko and all U.S. Pat. No. 4,927,298 issued May 22, 1990. U.S. Pat. No. 5,269,949 issued Dec. 14, 1993, U.S. Pat. No. 5,273,647 issued Dec. 28, 1993, application Ser. No. 08/238,903 filing date May 6, 1994 now abandoned. Application Ser. No. 08/402,175 filing date Mar. 10, 1955 now abandoned. U.S. Pat. No. 6,071.424 issued Jun. 6, 2000. Application Ser. No. 10/131425 filed May 22, 2002. U.S. Pat. No. 6,596,170B2 issued Jul. 22, 2003, Continuation in Part application Ser. No. 10/623.326 filed Jul. 19, 2003.

It is the U.S. Pat. No. 6,071,424 and application Ser. No. 10/131425 filed May 22, 2002 that generated the idea of cylindrical-telescopic cyclone structure and multi-compartment separation chamber cyclone. This idea is absolutely unique from time when first Bretney's cyclone was patented. Thus, the idea of cylindrical-telescopic cyclone structure and multi-compartment separation chamber apparatus is obvious of the intellectual property of the inventor of this U.S. Pat. No. 6,071,424.

Therefore, the object of the present invention is to propose such invented cyclone apparatus claims, they to prevent U.S. Pat. No. 6,071424 and application Ser. No. 10/131425 from being infringed with claims elements omitted in those two documents.

### SUMMARY OF THE INVENTION

This invention relates to a device for separating of particulate fluid suspension known as a cyclone separator, in which centrifugal forces of the revolving particulate suspension cause separation of the suspension into finer and coarser or light and denser fractions. The conventional of the conical predominating shape cyclone features of both high pressure drop and energy consumption to get a low separation efficiency for low capacity. This conical cyclone portion participates in creating so-called “back mix” and is vulnerable to be fast eroded.

To avoid those harmful phenomenons the present invention provides cylindrical-telescopic cyclone structure and multi-compartment separation chamber with air core or without it.

### BRIEF DESCRIPTION OF THE DRAWINGS

FIG. 1 is a view of the multi-housing section conventional cyclone having a conical one compartment separation chamber.

FIG. 2 is a cross-sectional view of FIG. 1.

FIG. 3 is a view of long-free vortex-telescopic separation chamber cyclone, invented as the method in U.S. Pat. No. 6,071,424.

FIG. 4 is a image of plurality cylindrical telescopic tubes as a pattern comprising multi-compartment cylindrical telescopic cyclone or as one compartment conventional conical cyclone.

FIG. 5 is a multi-compartment cylindrical telescopic separation chamber, being used in one housing section structure.

FIG. 6 is a multi-compartment cylindrical telescopic separation chamber being used in multi-section cylindrical telescopic housing structure.

FIG. 7 is a one compartment conventional conical separation chamber being used in multi-sectional cylindrical telescopic housing structure.

### DETAILED DESCRIPTION OF THE INVENTION

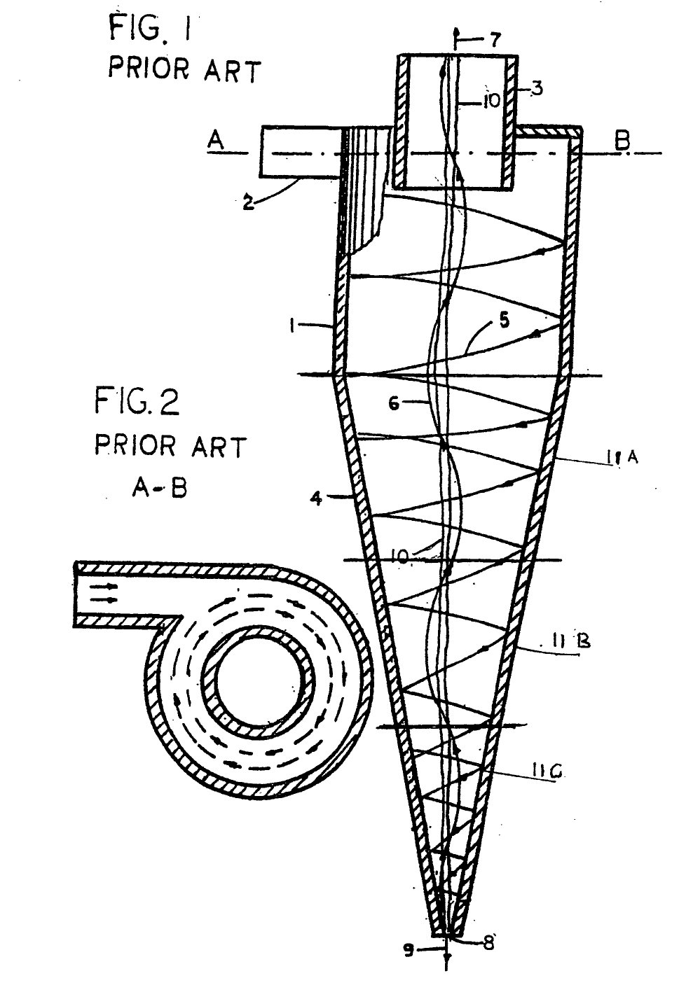

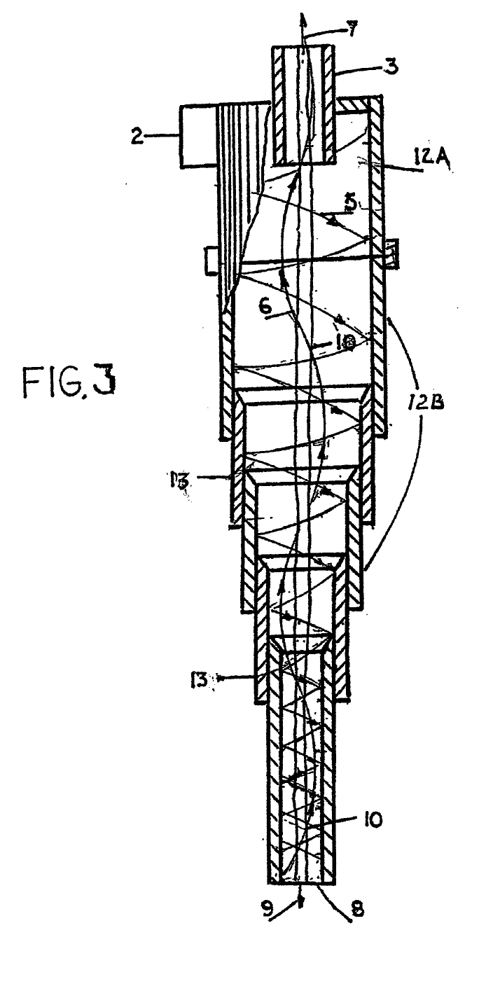

A conventional conical cyclone for separating of fluid mixtures which are centrifugally separable is illustrated in FIG. 1 and FIG. 2. This cyclone is comprised of short cylindrical portion 1 having an inlet duct 2 for introducing of a feed suspension or feed mixture in tangential direction. An exhaust or overflow pipe 3 extends through the top or ceiling wall of the cylindrical portion 1. A frustum-conical portion 4 is axially aligned with the exhaust pipe 3. In the portion 1 and 4 together as in separating chamber the feed suspension of feed mixture flows in the helical swirling flow pattern so to establish counter-flowing outer 5 and inner 6 vortexes within the separating chamber inherently causing solids in the fluid flow, which are smaller or lighter to move to the inner vortex 6 and exit through overflow pipe 3 as a smaller or lighter product stream or overflow 7. Ingredients in the fluid flow which are coarser or heavier move to the outer vortex 5 and exit through the outlet 8 as a coarser or heavier product stream or as underflow 9. Along the central hydrocyclone vertical axis the air core 10 is created, that extends from underflow outlet 8 throughout all long conical portion 4 cylindrical portion 1, and finally through the exhaust pipe 3.

Mostly the conical conventional cyclone portion consists of some amount of disconnectable sections, for example 11A, 11B and 11C.

In FIG. 3 is shown invented cyclone comprising of cyclone head 12A. inlet duct 2. exhaust or overflow pipe 3 and with separation chamber 12B. Said axially elongated separation chamber 12B. being telescopic, comprises a plurality of cylindrical telescopic tubes 13. The combined overall length of said tubes 13 is adjustable according to a solid particles distribution of the separated feed fluid. The invented cyclone when operating with or without inner vortex bed, with or without air core, is having always the smaller pressure drop and higher both capacity and separation efficiency, compared to those of conventional conical cyclone.

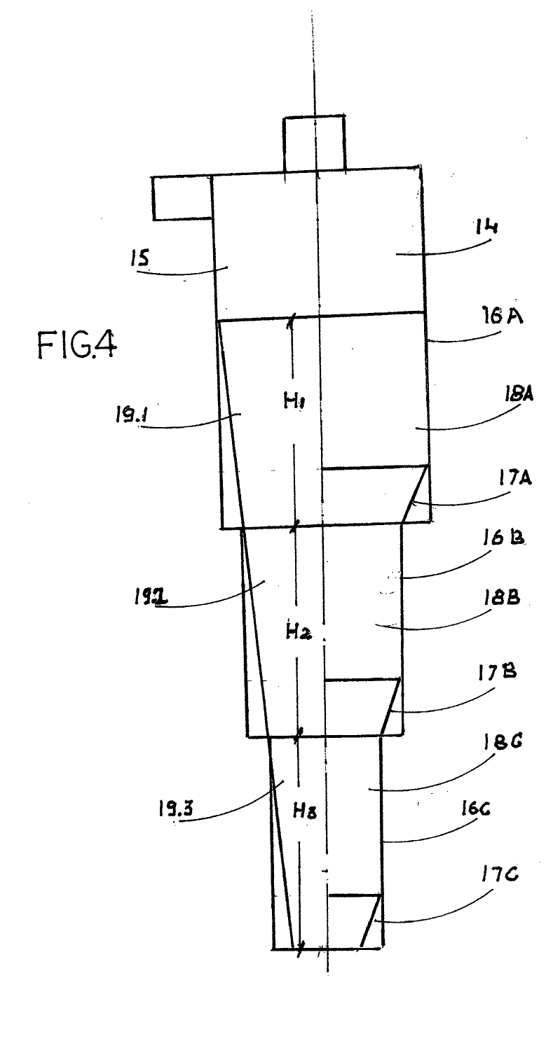

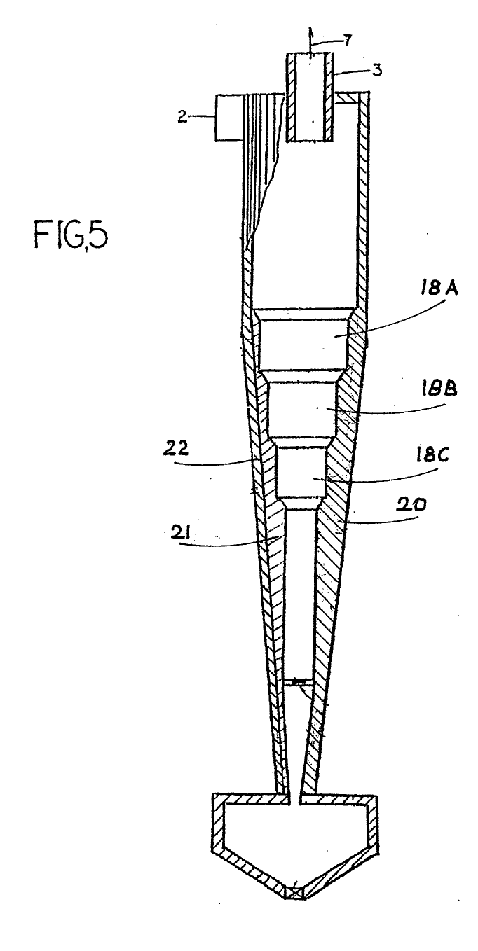

On FIG. 4 is shown an image of plurality cylindrical telescopic tubes as a pattern comprising a multi-compartment cylindrical-telescopic cyclone 14 or as one compartment conventional conical cyclone 15. On FIG. 4 right side is shown a multi-compartment cylindrical telescopic separation chamber, being telescopic 14 and comprising a plurality of cylindrical tubes 16A,B,C and short conical passages 17A,B,C. between them. One cylindrical tube 16 and short conical passage 17 create one separation chamber compartment 18A,B,C. On FIG. 4 left side is shown one compartment multi-sectional 19.1, 19.2, 19.3 conventional conical cyclone. In general case, the sectional heights can be different H1,2,3.

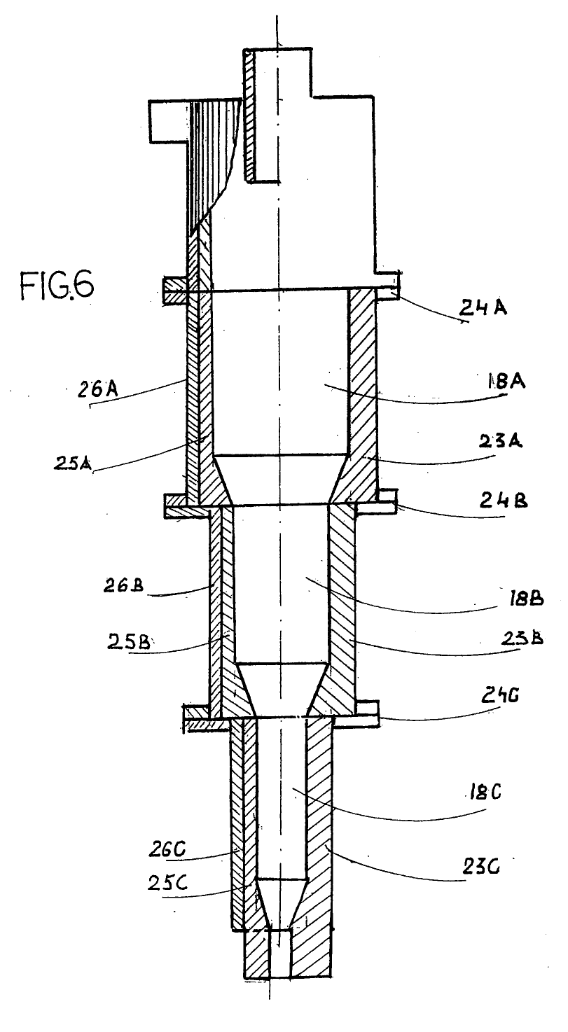

In FIG. 5 is shown the multi-compartment cylindrical telescopic separation chamber 18A,B,C structurally molded from one of the group consisting of plastic, epoxy, metal or another material molded along with all one section housing structure 20, or the multi-compartment cylindrical-telescopic cyclone separation chamber is formed from replaceable liners 21, structurally molded from one of the group consisting of plastic, epoxy, metal or another material and fitted in one section housing structure 22.

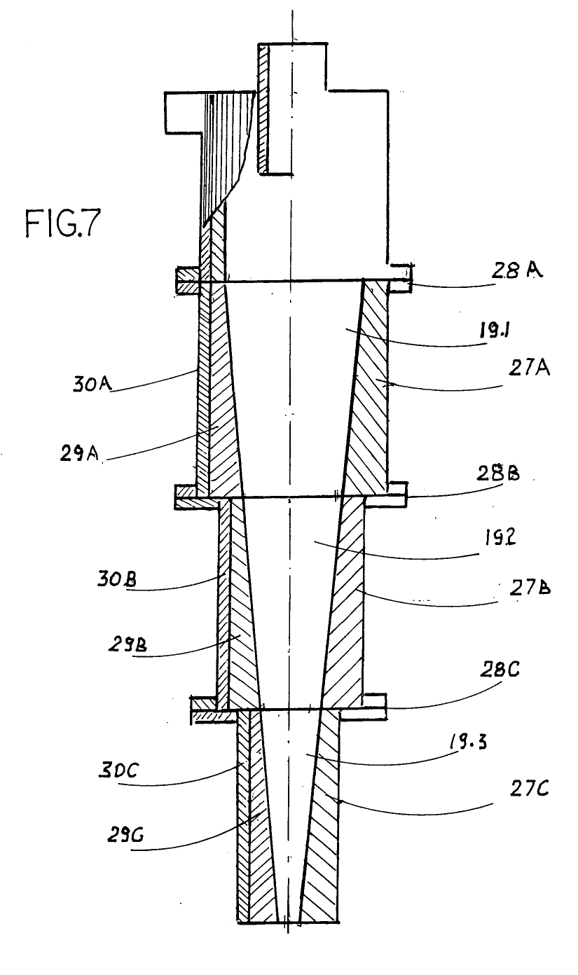

In FIG. 6 is shown the multi-compartment 18A,B,C cylindrical-telescopic chamber formed in multi-sectional cylindrical-telescopic housing structure 23A,B,C. Each of cylindrical-telescopic housing structure 23A,B,C is disconnectably joined with neighboring one for example with flanges. Each of the individual cylindrical telescopic separation chamber compartments 18A,B,C is molded from one of the group consisting of plastic, epoxy, metal or another material along with cylindrical telescopic housing section 23A,B,C or is formed from replaceable liners 25A,B,C from one of the group consisting of plastic, epoxy, metal or another material and fitted in cylindrical-telescopic housing section 26A,B,C.

In FIG. 7 is shown the conventional conical cyclone wherein one compartment multi-sectional 19.1, 19.2, 19.3 conical separation chamber is formed in multi-sectional cylindrical-telescopic housing structure. Each of the cylindrical telescopic housing structure 27A,B,C is disconnectably joined with neighboring one for example with flanges 28A,B,C. Said conical separation chamber sections 19.1, 19.2, 19.3 are molded from one of group consisting of plastic, epoxy, metal or another material along with all cylindrical-telescopic housing section 27A,B,C., or formed from replaceable liners 29A,B,C one of group consisting of plastic, epoxy, metal or another material and fitted in cylindrical-telescopic housing section 30A,B,C. The plurality of the cylindrical-telescopic housing section is joined with each other disconnectably.

The invention is not to be limited by the embodiment shown in the drawings or description in the specification which is given by way of example and not limitation, but only in accordance with scope of the appended claims.

9. In the cyclone apparatus, a feed fluid comprising solid-solid, solid-fluid particulate suspension delivered in fluid flow to a cyclone separator, having an axially elongated cylindrical conical separation chamber, a cylindrical upper portion and conical bottom portion the said cylindrical upper portion having an exhaust pipe, having a bottom region disposed is said upper portion of said separation chamber and an inlet duct disposed in said upper portion of said separation chamber for introducing said feed fluid in a tangential direction in a helical swirling flowing pattern so as to establish a circular velocity and counter-flowing inner and outer vortexes within the cylindrical-conical separation chamber, a lighter portion of said feed fluid moves to the inner vortex and exit through the exhaust pipe as overflow and the feed fluid moves to the outer vortex and exit through the bottom outlet, as underflow, the improvement in the apparatus comprising:
Axially elongated cylindrical separation chamber being telescopic and comprising a plurality of cylindrical telescopic tubes having a combined overall length, the combined overall length being adjustable, wherein the combined overall length is separated feed fluid.

10. The plurality of cylindircal-telescopic tubes is a pattern comprising multi-compartment cylindircal-telescopic cyclone or one compartment conical conventional cyclone.

11. The improved apparatus according to claim 10 wherein the multi-compartment cylindrical-telescopic cyclone separation chamber is structurally molded from one of the group consisting of plastic, epoxy, metal or another material, along with all one section housing structure, or the multi-compartment cylindrical telescopic cyclone separation chamber is formed from replaceable liners structurally molded from one of the group consisting of plastic, epoxy, metal or another material and fitted in one section housing structure.

12. The improved apparatus according to claim 10 wherein the multi-compartment cylindrical-telescopic separation chamber is formed in multi-sectional cylindrical-telescopic housing structure.

13. The improved apparatus according to claim 12 wherein the individual cylindrical-telescopic separation chamber compartment is molded from one of the group consisting of plastic, epoxy, metal or another material, along with all cylindrical-telescopic housing section or is formed from replaceable liners from one of the group consisting of plastic, epoxy, metal or another material and fitted in cylindrical-telescopic housing section.

14. The improved apparatus according to claim 10 wherein one compartment multi-sectional conical separation chamber is formed in multi-sectional cylindrical-telescopic housing structure.

15. The improved apparatus according to claim 14 wherein the conical separation chamber sections are molded from one group consisting of plastic, epoxy, metal, or another material along with all cylindrical-telescopic housing section, or is formed from replaceable liners from one or the group consisting of plastic, epoxy, metal or another material and fitted in cylindrical-telescopic housing section.

16. The improved apparatus according to claim 10, wherein the cylindircal-telescopic tubes comprising plurality of cylindrical-telescopic housing sections are joined each other disconnectably.

17. The improved apparatus according to claim 10, wherein the cylindircal-telescopic tubes comprising plurality of cylindrical-telescopic housing sections can have each other a different heights.
